(19) United States
(12) Patent Application Publication
(10) Pub. No.: US 2024/0430905 A1
(43) Pub. Date: Dec. 26, 2024

(54) COLLISION HANDLING FOR TWO-STAGE DOWNLINK CONTROL INFORMATION

(71) Applicant: QUALCOMM Incorporated, San Diego, CA (US)

(72) Inventors: Huilin XU, Temecula, CA (US); Jing SUN, San Diego, CA (US); Xiao Feng WANG, San Diego, CA (US)

(21) Appl. No.: 18/338,228

(22) Filed: Jun. 20, 2023

(51) Int. Cl. H04W 72/232; H04W 72/1273; H04W 72/541

(52) U.S. Cl. CPC H04W 72/232; H04W 72/1273; H04W 72/541

(57) ABSTRACT

Various aspects of the present disclosure generally relate to wireless communication. In some aspects, a user equipment (UE) may detect a collision between one or more of a first-stage downlink control information (DCI) or a second-stage DCI, of a two-stage DCI, and a symbol in which a physical downlink control channel (PDCCH) is not monitored by the UE. The UE may perform a collision handling for the two-stage DCI based at least in part on the collision, wherein the collision handling is based at least in part on one of: a prioritization of the two-stage DCI, a fallback to a single-stage DCI, or a shift of the first-stage DCI. Numerous other aspects are described.

### FIELD OF THE DISCLOSURE

Aspects of the present disclosure generally relate to wireless communication and to techniques and apparatuses for collision handling for two-stage downlink control information (DCI).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes one or more memories; and one or more processors coupled to the one or more memories, the one or more processors individually or collectively configured to: detect a collision between one or more of a first-stage downlink control information (DCI) or a second-stage DCI, of a two-stage DCI, and a symbol in which a physical downlink control channel (PDCCH) is not monitored by the UE; and perform a collision handling for the two-stage DCI based at least in part on the collision, wherein the collision handling is based at least in part on one of: a prioritization of the two-stage DCI, a fallback to a single-stage DCI, or a shift of the first-stage DCI.

In some implementations, a method of wireless communication performed by a UE includes detecting a collision between one or more of a first-stage DCI or a second-stage DCI, of a two-stage DCI, and a symbol in which a PDCCH is not monitored by the UE; and performing a collision handling for the two-stage DCI based at least in part on the collision, wherein the collision handling is based at least in part on one of: a prioritization of the two-stage DCI, a fallback to a single-stage DCI, or a shift of the first-stage DCI.

In some implementations, a non-transitory computer-readable medium storing a set of instructions for wireless communication includes one or more instructions that, when executed by one or more processors of a UE, cause the UE to: detect a collision between one or more of a first-stage DCI or a second-stage DCI, of a two-stage DCI, and a symbol in which a PDCCH is not monitored by the UE; and perform a collision handling for the two-stage DCI based at least in part on the collision, wherein the collision handling is based at least in part on one of: a prioritization of the two-stage DCI, a fallback to a single-stage DCI, or a shift of the first-stage DCI.

In some implementations, an apparatus for wireless communication includes means for detecting a collision between one or more of a first-stage DCI or a second-stage DCI, of a two-stage DCI, and a symbol in which a PDCCH is not monitored by the apparatus; and means for performing a collision handling for the two-stage DCI based at least in part on the collision, wherein the collision handling is based at least in part on one of: a prioritization of the two-stage DCI, a fallback to a single-stage DCI, or a shift of the first-stage DCI.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a physical downlink control channel (PDCCH) dropping for multiple-stage downlink control information (DCI), in accordance with the present disclosure.

FIGS. 5-7 are diagrams illustrating examples associated with collision handling for two-stage DCI, in accordance with the present disclosure.

FIG. 8 is a diagram illustrating an example process associated with collision handling for two-stage DCI, in accordance with the present disclosure.

FIG. 9 is a diagram of an example apparatus for wireless communication, in accordance with the present disclosure.

### DETAILED DESCRIPTION

A downlink control information (DCI), which may be received by a user equipment (UE) from a network node via a physical downlink control channel (PDCCH), may be split into a first-stage DCI and a second-stage DCI. The first-stage DCI may include a minimum amount of information for the UE to start processing samples, and remaining information for channel decoding may be included in the second-stage DCI.

The two-stage DCI may be more vulnerable to a PDCCH dropping than the single-stage DCI. A PDCCH monitoring occasion (PMO) may collide with a measurement gap or a cross-link interference (CLI) measurement occasion, in which case the UE may not monitor a PDCCH. The UE may skip a PDCCH monitoring during the PMO. Scheduling information may not be fully provided to the UE when the first-stage DCI or the second-stage DCI is dropped due to the PMO being skipped. A PDCCH dropping rate for the two-stage DCI may be double that of the single-stage DCI, since either the first-stage DCI or the second-stage DCI being dropped may result in the scheduling information not being fully provided to the UE. When the first-stage DCI that is dropped is associated with multiple second-stage DCIs, the PDCCH dropping may be further increased. As a result, PDCCH dropping for multiple stage DCIs may degrade a performance of the UE.

Various aspects relate generally to collision handling for two-stage DCI. Some aspects more specifically relate to collision handling for two-stage DCI based at least in part on a prioritization of the two-stage DCI, a fallback to a single-stage DCI, or a shift of a first-stage DCI. In some examples, a UE may detect a collision between a first-stage DCI and/or a second-stage DCI, of a two-stage DCI, and a symbol in which a PDCCH is not monitored by the UE. The collision may be a PDCCH collision with a measurement gap or a CLI measurement occasion. The first-stage DCI and/or the second-stage DCI may collide with other symbols or the measurement gap. The UE may perform a collision handling for the two-stage DCI based at least in part on the collision. The collision handling may alleviate the problem of the first-stage DCI and/or the second-stage DCI colliding with the other symbols or the measurement gap. The collision handling may be based at least in part on a prioritization of the two-stage DCI, a fallback to a single-stage DCI (e.g., based at least in part on a potential PDCCH dropping), or a shift of the first-stage DCI (e.g., a time shift of a first-stage DCI PMO when an original PMO was dropped). The collision handling may involve monitoring the two-stage DCI only when both the first-stage DCI and the second-stage DCI are dropped.

Particular aspects of the subject matter described in this disclosure can be implemented to realize one or more of the following potential advantages. In some examples, by implementing the collision handling for the two-stage DCI, the described techniques can be used to increase a likelihood that scheduling information is received by the UE, thereby improving a performance of the UE. The collision handling may ensure that the first-stage DCI and the second-stage DCI are both successfully received by the UE, such that a likelihood of some scheduling information being dropped (e.g., not received by the UE) may be reduced, thereby improving the performance of the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

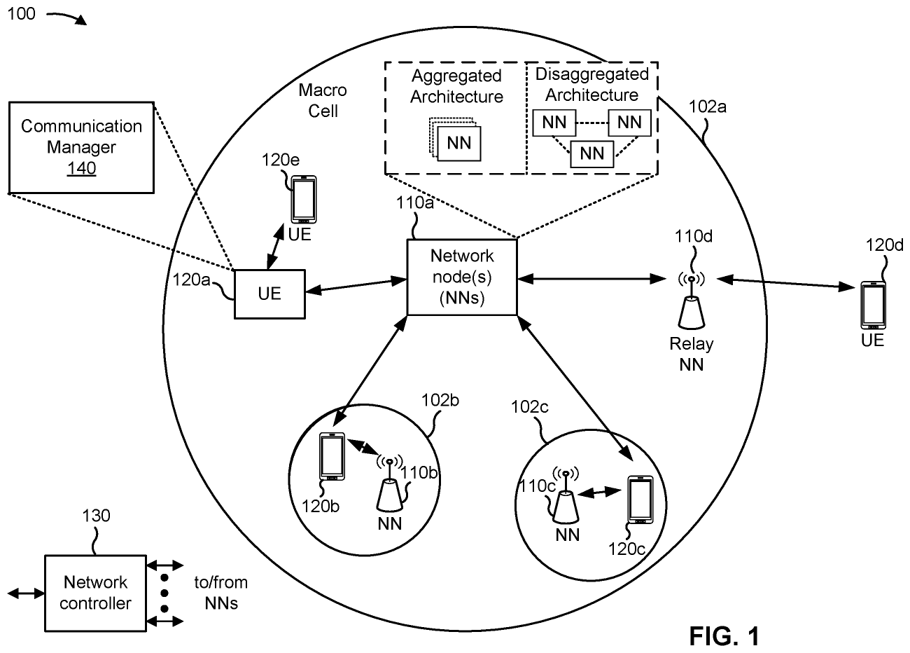

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHZ). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may detect a collision between one or more of a first-stage DCI or a second-stage DCI, of a two-stage DCI, and a symbol in which a PDCCH is not monitored by the UE; and perform a collision handling for the two-stage DCI based at least in part on the collision, wherein the collision handling is based at least in part on one of: a prioritization of the two-stage DCI, a fallback to a single-stage DCI, or a shift of the first-stage DCI. Additionally, or alternatively, the communication manager 140 may perform one or more other operations described herein.

As indicated above, FIG. 1 is provided as an example. Other examples may differ from what is described with regard to FIG. 1.

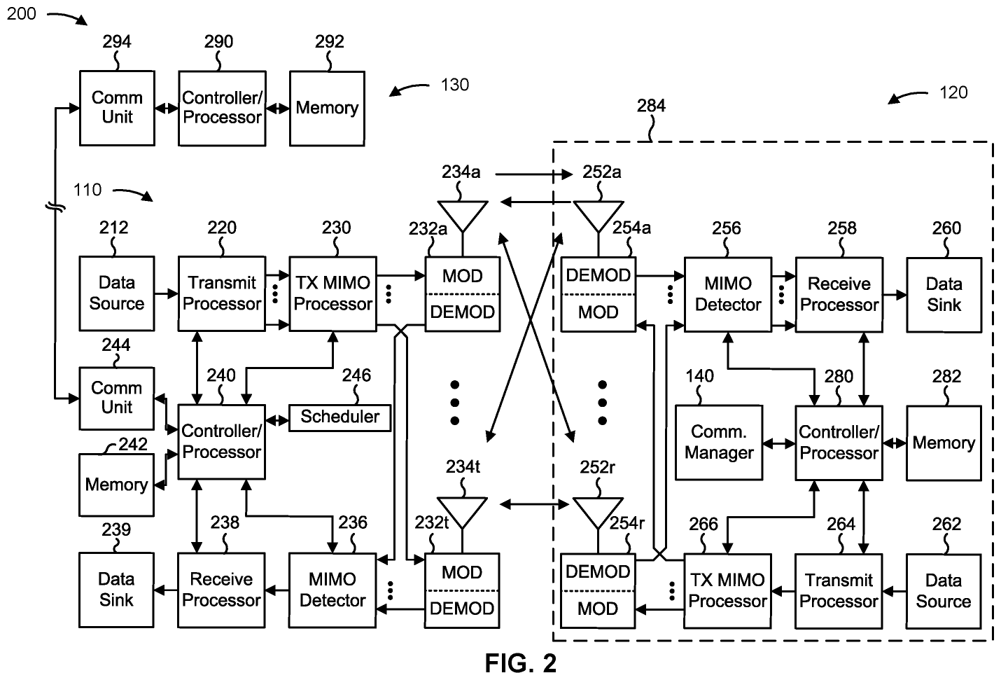

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

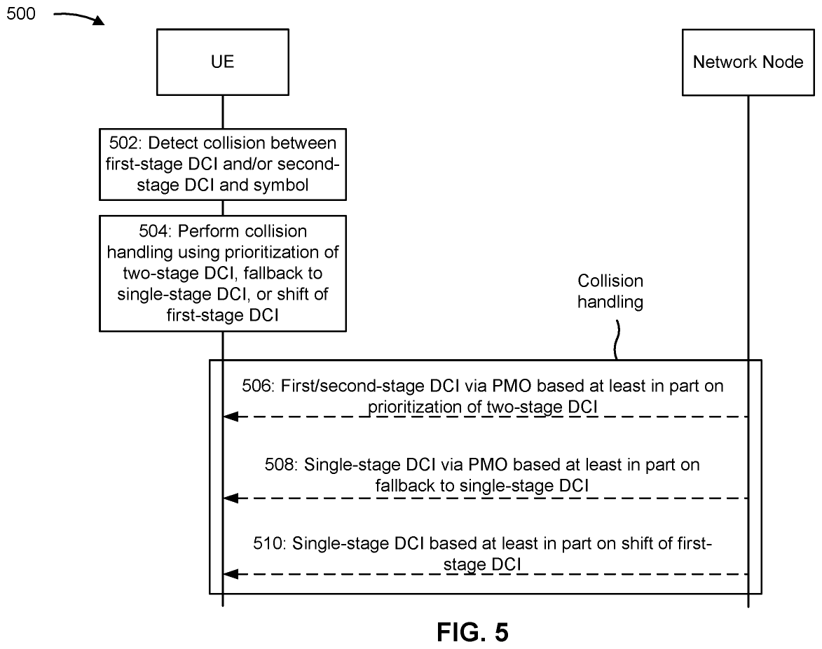

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

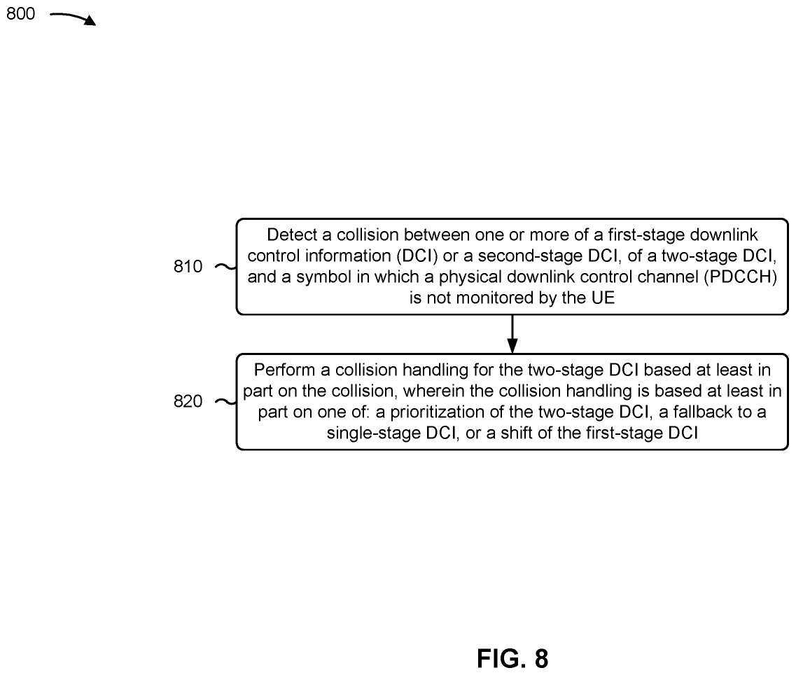

The controller/processor 240 of the network node 110, the controller/processor 280 of the UE 120, and/or any other component(s) of FIG. 2 may perform one or more techniques associated with collision handling for two-stage DCI, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, and/or other processes as described herein. In some examples, executing instructions may include running the instructions, converting the instructions, compiling the instructions, and/or interpreting the instructions, among other examples.

In some aspects, a UE (e.g., the UE 120) includes means for detecting a collision between one or more of a first-stage DCI or a second-stage DCI, of a two-stage DCI, and a symbol in which a PDCCH is not monitored by the UE; and/or means for performing a collision handling for the two-stage DCI based at least in part on the collision, wherein the collision handling is based at least in part on one of: a prioritization of the two-stage DCI, a fallback to a single-stage DCI, or a shift of the first-stage DCI. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

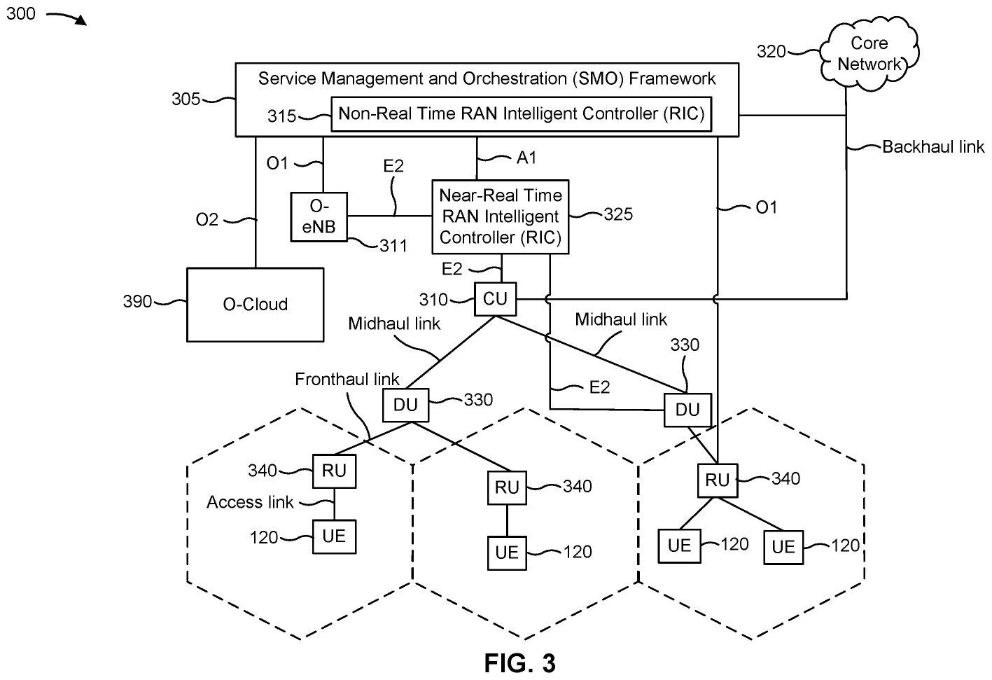

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A single-stage DCI may be based at least in part on a control resource set (CORESET), a search space set, PMOs, PDCCH candidates, and/or conditions associated with skipping a PDCCH monitoring.

A two-stage DCI may be applicable for various use cases. The two-stage DCI may be associated with a downlink processing time enhancement. A network node may schedule downlink resources before a hybrid automatic repeat request acknowledgement (HARQ-ACK) for an early physical downlink shared channel (PDSCH) is received. A UE may start a reference signal processing and a channel estimation before the second-stage DCI is received. The two-stage DCI may be associated with an uplink processing time enhancement. The UE may start preparing uplink data after the UE receives a first-stage DCI with minimum information. The two-stage DCI may be associated with a blind decoding reduction. A DCI size may be aligned among different first-stage DCI formats. The two-stage DCI may be associated with a control overhead reduction. The first-stage DCI may provide common scheduling information for scheduling multiple transmissions, and individual second-stage DCIs may provide link adaptation scheduling information. The two-stage DCI may be associated with a robust transmission (e.g., in a relatively wide beam or in a relatively narrow beam, and with a relatively high spectral efficiency).

The first-stage DCI may include a minimum amount of information for the UE to start processing samples, and remaining information for channel decoding may be included in the second-stage DCI. A functional splitting may occur between the first-stage DCI and the second-stage DCI. The first-stage DCI may include demodulation related parameters, such as MIMO related information, antenna information, a modulation order, a resource allocation, a DMRS configuration, and/or a resource location for the second-stage DCI. The second-stage DCI may include decoding related information, such as a HARQ process identifier (ID), a redundancy version identifier (RVID), a new data indicator (NDI), a code rate, an MCS adjustment, a power control, and/or beam information.

The two-stage DCI may be more vulnerable to a PDCCH dropping than the single-stage DCI. A PMO may collide with a measurement gap or a CLI measurement occasion, in which case the UE may not monitor a PDCCH. The UE may skip a PDCCH monitoring during the PMO. The PDCCH may be canceled by a flexible symbol indicated by a slot format indicator (SFI). A PDCCH skipping may be indicated by a network node. Scheduling information may not be fully provided to the UE when the first-stage DCI or the second-stage DCI is dropped due to the PMO being skipped. A PDCCH dropping rate for the two-stage DCI may be double that of the single-stage DCI, since either the first-stage DCI or the second-stage DCI being dropped may result in the scheduling information not being fully provided to the UE. When the first-stage DCI that is dropped is associated with multiple second-stage DCIs, the PDCCH dropping may be further increased. As a result, PDCCH dropping for multiple stage DCIs may degrade a performance of the UE.

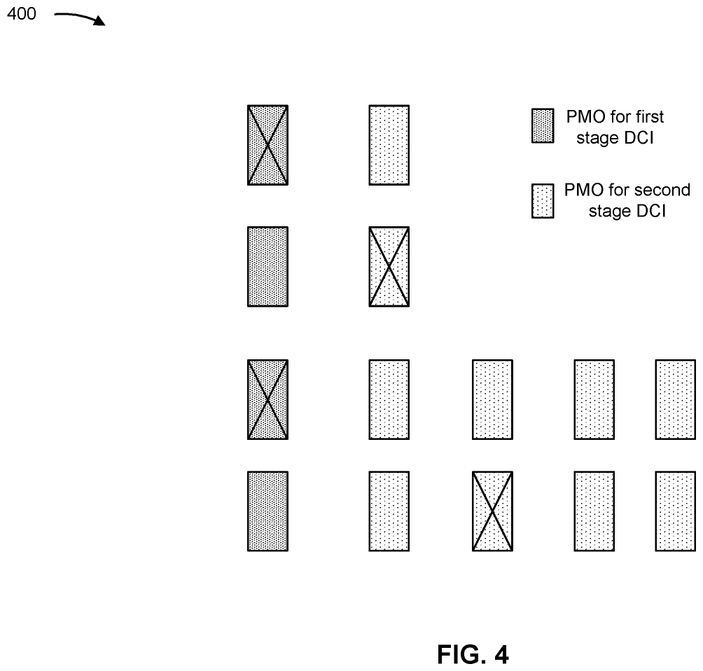

FIG. 4 is a diagram illustrating an example 400 of a PDCCH dropping for multiple stage DCIs, in accordance with the present disclosure.

As shown in FIG. 4, PMOs may be associated with a first-stage DCI and a second-stage DCI. A PMO may be skipped due to a collision with a measurement gap or a CLI measurement occasion. The PMO may be skipped due to a PDCCH cancelation (e.g., by a flexible symbol indicated by an SFI DCI). The PMO may be skipped due to a PDCCH skipping, which may be indicated by a network node. When the PMO is skipped, a corresponding PDCCH may be dropped. Scheduling information may not be fully provided whenever the first-stage DCI or the second-stage DCI is dropped, which may degrade a performance of a UE.

As indicated above, FIG. 4 is provided as an example. Other examples may differ from what is described with regard to FIG. 4.

In various aspects of techniques and apparatuses described herein, a UE may detect a collision between a first-stage DCI and/or a second-stage DCI, of a two-stage DCI, and a symbol in which a PDCCH is not monitored by the UE. The collision may be a PDCCH collision with a measurement gap or a CLI measurement occasion. The first-stage DCI and/or the second-stage DCI may collide with other symbols or the measurement gap. The UE may perform a collision handling for the two-stage DCI based at least in part on the collision. The collision handling may alleviate the problem of the first-stage DCI and/or the second-stage DCI colliding with the other symbols or the measurement gap. The collision handling may be based at least in part on a prioritization of the two-stage DCI, a fallback to a single-stage DCI (e.g., based at least in part on a potential PDCCH dropping), or a shift of the first-stage DCI (e.g., a time shift of a first-stage DCI PMO when an original PMO was skipped). The collision handling may involve monitoring the two-stage DCI only when both the first-stage DCI and the second-stage DCI are not dropped. As a result, the collision handling may increase a likelihood that scheduling information is received by the UE, thereby improving a performance of the UE. In other words, by ensuring that the first-stage DCI and the second-stage DCI are both successfully received by the UE, a likelihood of some scheduling information being dropped (e.g., not received by the UE) may be reduced, thereby improving the performance of the UE.

FIG. 5 is a diagram illustrating an example 500 associated with collision handling for two-stage DCI, in accordance with the present disclosure. As shown in FIG. 5, example 500 includes communication between a UE (e.g., UE 120) and a network node (e.g., network node 110). In some aspects, the UE and the network node may be included in a wireless network, such as wireless network 100.

As shown by reference number 502, the first UE may detect a collision (e.g., in time and/or in frequency) between a first-stage DCI and/or a second-stage DCI, of a two-stage DCI, and a symbol in which a PDCCH is not monitored by the UE. The first-stage DCI and the second-stage DCI may be associated with separate PMOs. The first UE may detect that the first-stage DCI and/or the second-stage DCI collides with the symbol. The collision may be based at least in part on a PDCCH collision with a measurement gap. The collision may be based at least in part on a PDCCH collision with a CLI measurement occasion. The collision may be associated with a PDCCH skipping, and the first-stage DCI and the second-stage DCI may fall in a PDCCH skipping duration. A PMO associated with the first-stage DCI or the second-stage DCI may collide with the measurement gap or the CLI measurement occasion. The PMO may be canceled by an SFI, or the network node may indicate that the PMO should be skipped.

As shown by reference number 504, the UE may perform a collision handling for the two-stage DCI based at least in part on the collision. The collision handling may be based at least in part on a prioritization of the two-stage DCI, a fallback to a single-stage DCI, or a shift of the first-stage DCI. In some aspects, a two-stage DCI dropping issue may be reduced by prioritizing the two-stage DCI, implementing the fallback to the single-stage DCI, and/or deferring a collided first-stage DCI. Some UE operations may have a higher priority than PDCCH monitoring, which may be semi-statically configured via RRC signaling, which may cause the UE to skip the PDCCH monitoring.

As shown by reference number 506, the UE may receive, from the network node via a PMO and based at least in part on the collision handling, the first-stage DCI and/or the second-stage DCI, of the two-stage DCI, based at least in part on the prioritization of the two-stage DCI. In some aspects, the first-stage DCI may collide with the symbol. In this case, the UE may receive the first-stage DCI via the PMO based at least in part on the prioritization of the two-stage DCI. In some aspects, the second-stage DCI may collide with the symbol. In this case, the UE may receive the second-stage DCI via the PMO based at least in part on the prioritization of the two-stage DCI. In some aspects, the first-stage DCI and the second-stage DCI may collide with symbols in which PDCCHs are not monitored by the UE. In this case, the UE may receive, based at least in part on the collision handling, the first-stage DCI and the second-stage DCI via PMOs based at least in part on the prioritization of the two-stage DCI. In some aspects, the first-stage DCI or the second-stage DCI may not collide with the symbol. In some aspects, the second-stage DCI may be associated with a dynamically scheduled channel, and a higher layer configured channel associated with the symbol may be dropped over the dynamically scheduled channel. The second-stage DCI may be associated with the dynamically scheduled channel based at least in part on a collision with a flexible symbol indicated by an SFI.

In some aspects, a likelihood of a PDCCH dropping for two-stage DCI may be reduced by prioritizing the two-stage DCI when the first-stage DCI or the second-stage DCI, of the two-stage DCI, collides with the symbol in which the PDCCH is not monitored. After the prioritization, the UE may be allowed to fully receive a PDCCH for the two-stage DCI. When the first-stage DCI collides with the symbol, the UE may prioritize the first-stage DCI over the symbol, and the UE may be allowed to fully receive a PDCCH for the first-stage DCI. When the second-stage DCI collides with the symbol, the UE may prioritize the second-stage DCI over the symbol, and the UE may be allowed to fully receive a PDCCH for the second-stage DCI. When both the first-stage DCI and the second-stage DCI collide with symbols in which the PDCCH is not monitored, the UE may prioritize the first-stage DCI and the second-stage DCI over the symbols, and the UE may be allowed to fully receive PDCCHs for the first-stage DCI and the second-stage DCI. When the first-stage DCI or the second-stage DCI does not collide with the symbol, the UE may prioritize the first-stage DCI or the second-stage DCI over the symbol. In some cases, the second-stage DCI may be treated as the dynamically scheduled channel, as opposed to a semi-static scheduled channel, which may allow the second-stage DCI to have a higher priority than the symbol in which the PDCCH is not monitored.

In some aspects, the first-stage DCI and/or the second-stage DCI colliding with the symbol, or the first-stage DCI and/or the second-stage DCI not colliding with the symbol, may be applicable to PDCCH collisions with measurement gaps or CLI measurement occasions. The first-stage DCI and/or the second-stage DCI colliding with the symbol may apply to the PDCCH skipping. The PDCCH skipping may take effect when both the first-stage DCI and the second-stage DCI fall into the PDCCH skipping duration. When the first-stage DCI and/or the second-stage DCI does not collide with the symbol, a PDCCH dropping may take effect when both the first-stage DCI and the second-stage DCI are collided. The second-stage DCI being treated as the dynamically scheduled channel may apply to a collision with the presence of the SFI (e.g., a flexible symbol indicated by SFI DCI). In this case, a higher layer configured channel may be dropped, but the second-stage DCI as the dynamically scheduled channel may not be dropped.

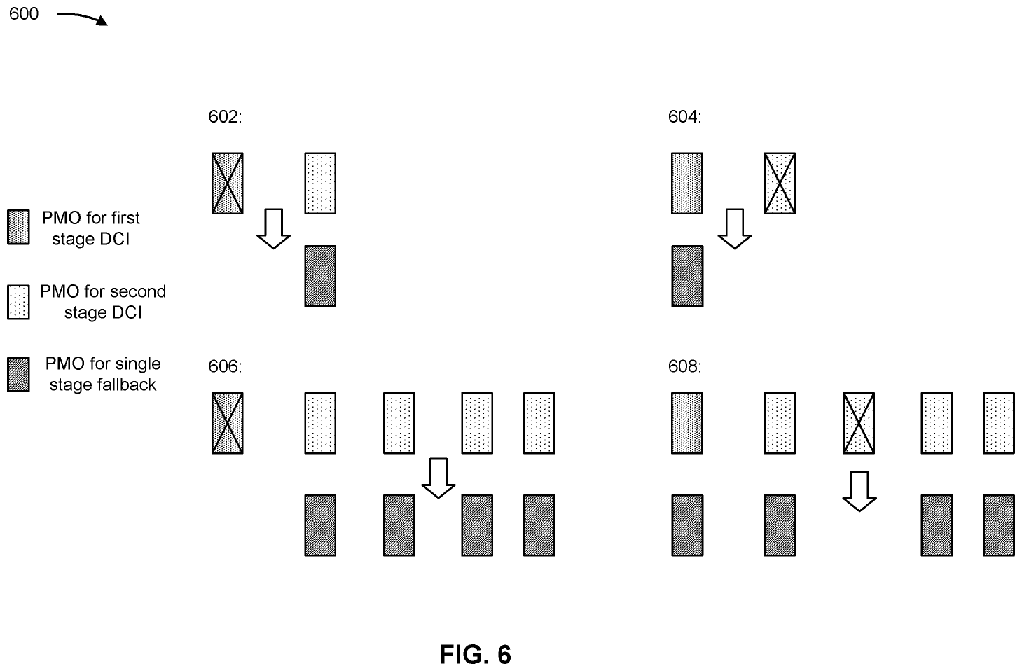

As shown by reference number 508, the UE may receive, from the network node via a PMO and based at least in part on the collision handling, the single-stage DCI instead of the two-stage DCI based at least in part on the fallback to the single-stage DCI. In some aspects, the UE may fall back to the single-stage DCI when the first-stage DCI or the second-stage DCI is subject to the collision, which may cause the PDCCH dropping (e.g., as shown in FIG. 6). When the first-stage DCI or the second-stage DCI collides with a symbol in which a PDCCH monitoring is not allowed, the network node may fall back to transmitting the single-stage DCI. The network node may transmit the single-stage DCI on the PMO, which may not collide with the symbol in which the PDCCH monitoring is skipped.

As shown by reference number 510, the first-stage DCI may collide with the symbol, and the UE may receive, from the network node and based at least in part on the collision handling, the first-stage DCI based at least in part on the shift of the first-stage DCI to a slot in which the PDCCH monitoring is allowed. The slot may be a first slot among a plurality of slots in which a PDCCH is transmitted. The slot may be a first slot associated with a PMO for the second-stage DCI. The UE may receive, from the network node, the second-stage DCI based at least in part on a shift of the second-stage DCI to a next PMO for the second-stage DCI. Alternatively, the UE may receive, from the network node, the second-stage DCI without a shift of the second-stage DCI. The slot may be a first slot configured by a network node based at least in part on an offset. The slot may be configured with a PMO for a specific DCI format, the slot may be configured with a specific CORESET, or the slot may be configured with a specific search space set.

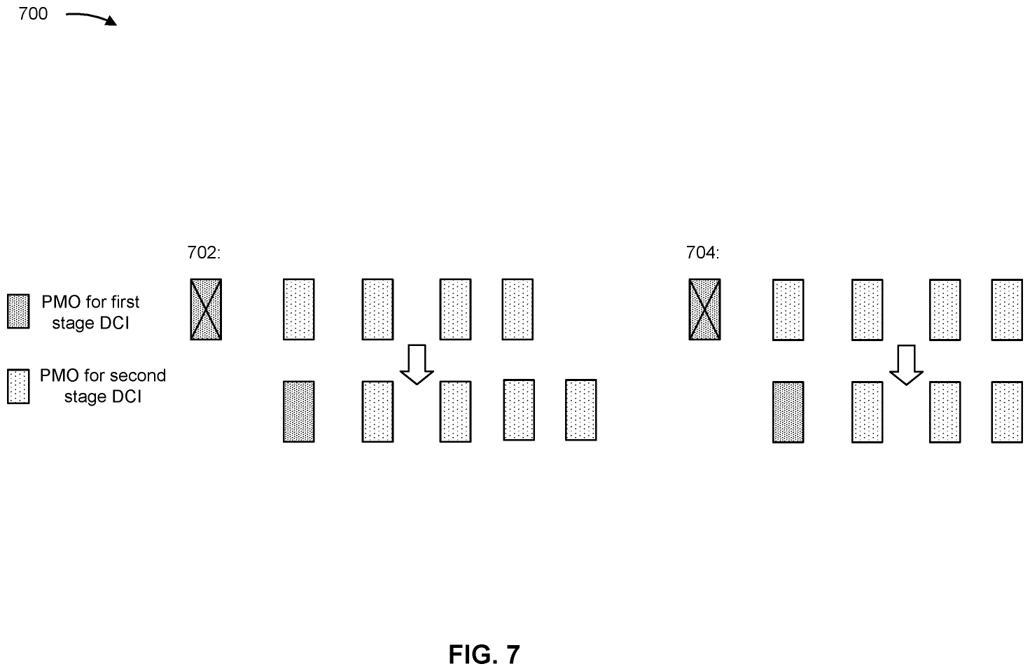

In some aspects, when the first-stage DCI is associated with the collision, a collided PMO may be deferred to a first PMO that does not collide (e.g., a first PMO that is not associated with a collision), which may be useful for one first-stage DCI that is associated with multiple second-stage DCIs. In some aspects, when the first-stage DCI collides with the symbol for which the PDCCH monitoring is not allowed, the first-stage DCI may be shifted to the next slot in which the PDCCH is allowed to transmit (e.g., as shown in FIG. 7). When the first-stage DCI is shifted to the next slot, the next slot may be converted into a PMO for the first-stage DCI.

In some aspects, the slot that is converted into the PMO for the first-stage DCI may be the first slot among the plurality of slots in which the PDCCH is able to be transmitted. The slot that is converted into the PMO for the first-stage DCI may be the first slot containing the PMO for the second-stage DCI. The second-stage DCI may also be shifted to the next PMO for the second-stage DCI, or alternatively, the second-stage DCI may not be shifted. The slot that is converted into the PMO for the first-stage DCI may be the first slot configured by the network node (e.g., with the offset to the slot in which the first-stage DCI is configured). The slot may be configured with the PMO for the specific DCI format, the specific CORESET, or the specific search space set.

In some aspects, the UE may not monitor the first-stage DCI based at least in part on the first-stage DCI colliding with the symbol. In this case, the UE may determine, based at least in part on the collision handling, to not monitor the second-stage DCI. In some aspects, the UE may not receive the second-stage DCI based at least in part on the second-stage DCI colliding with the symbol. In this case, the UE may determine, based at least in part on the collision handling, to not monitor the first-stage DCI based at least in part on the first-stage DCI being associated with a single second-stage DCI. Alternatively, the UE may determine, based at least in part on the collision handling, to not monitor the first-stage DCI based at least in part on a plurality of second-stage DCIs for the first-stage DCI not being received.

In some aspects, a likelihood of a two-stage DCI dropping may be alleviated by defining a baseline rule for the UE to handle the two-stage DCI dropping. The baseline rule may enable the UE to perform the collision handling for two-stage DCI. The UE may be able to prioritize the two-stage DCI, implement the fallback to the single-stage DCI, and/or defer the collided first-stage DCI based at least in part on a UE capability. For example, a prioritization of the two-stage DCI, an implementation of the fallback to the single-stage DCI, and/or a deference of the collided first-stage DCI may be optional features that are supported based at least in part on the UE capability. Some optional features may not be supported for low-tier UEs.

In some aspects, when the first-stage DCI is not monitored due to the collision with the symbol in which PDCCH monitoring is not allowed, the UE may not monitor the second-stage DCI. In some aspects, when the second-stage DCI is not received due to the collision with the symbol in which PDCCH monitoring is not allowed, the UE may not monitor the first-stage DCI when the first-stage DCI is associated with the single second-stage DCI. Alternatively, when the second-stage DCI is not received due to the collision with the symbol in which PDCCH monitoring is not allowed, the UE may not monitor the first-stage DCI when the plurality of second-stage DCIs (e.g., all second-stage DCIs) for the first-stage DCI are not received.

As indicated above, FIG. 5 is provided as an example. Other examples may differ from what is described with regard to FIG. 5.

FIG. 6 is a diagram illustrating an example 600 associated with collision handling for two-stage DCI, in accordance with the present disclosure.

As shown by reference number 602, a PMO for a first-stage DCI may be associated with a collision (e.g., a collision with a symbol in which a PDCCH monitoring is not allowed). In this case, a network node may transmit a single-stage DCI in a PMO for single-stage DCI fallback. The PMO for single-stage DCI fallback may not collide with a symbol in which the PDCCH monitoring is skipped. The single-stage DCI may include information associated with both the first-stage DCI (which was dropped) and a second-stage DCI. As shown by reference number 604, a PMO for a second-stage DCI may be associated with a collision. In this case, a network node may transmit a single-stage DCI in a PMO for single-stage DCI fallback. The single-stage DCI may include information associated with both the second-stage DCI (which was dropped) and a first-stage DCI.

As shown by reference number 606, a PMO for a first-stage DCI may be associated with a collision. The first-stage DCI may be associated with multiple second-stage DCIs. In this case, a network node may transmit multiple single-stage DCIs in multiple PMOs for single-stage DCI feedback. The network node may transmit a separate single-stage DCI feedback for each of the multiple second-stage DCIs. As shown by reference number 608, a PMO for a second-stage DCI may be associated with a collision. The second-stage DCI may be one of multiple second-stage DCIs associated with a first-stage DCI. In this case, a network node may transmit a single-stage DCI in multiple PMOs for single-stage DCI feedback, which may correspond to the first-stage DCI, and second-stage DCI is not associated with the collision. In some cases, a data channel (e.g., a mini-slot transmission for ultra-reliable, low-latency communications (URLLC)) scheduled by a dropped second-stage DCI may be canceled together with the dropped second-stage DCI. Such a design may not be sufficient when more than one second-stage DCI is dropped.

As indicated above, FIG. 6 is provided as an example. Other examples may differ from what is described with regard to FIG. 6.

FIG. 7 is a diagram illustrating an example 700 associated with collision handling for two-stage DCI, in accordance with the present disclosure.

As shown by reference number 702, a first-stage DCI of a two-stage DCI may collide with a symbol in which PDCCH monitoring is not allowed. The first-stage DCI may be shifted to a next slot in which a PDCCH is allowed to be transmitted. The next slot may be a first slot containing a PMO for a second-stage DCI. The second-stage DCI may also be shifted to a next PMO for the second-stage DCI.

As shown by reference number 704, a first-stage DCI of a two-stage DCI may collide with a symbol in which PDCCH monitoring is not allowed. The first-stage DCI may be shifted to a next slot in which a PDCCH is allowed to be transmitted. The next slot may be a first slot containing a PMO for a second-stage DCI. The second-stage DCI may not be shifted.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with collision handling for two-stage DCI.

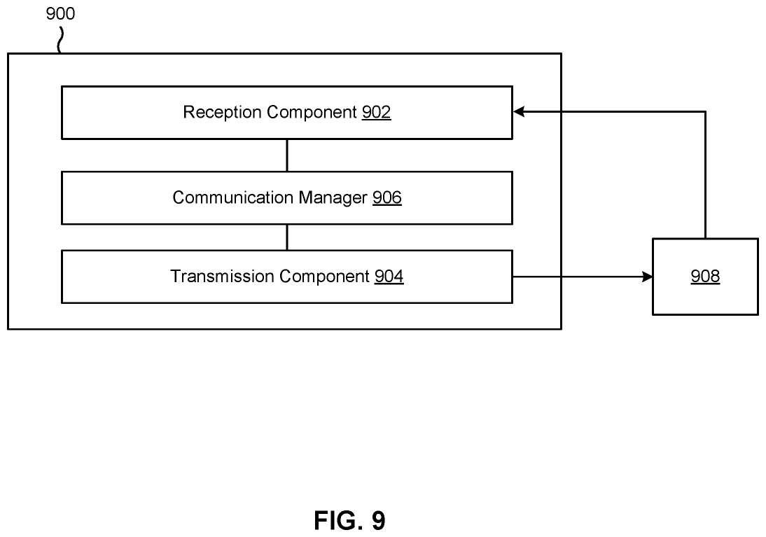

As shown in FIG. 8, in some aspects, process 800 may include detecting a collision between one or more of a first-stage DCI or a second-stage DCI, of a two-stage DCI, and a symbol in which a PDCCH is not monitored by the UE (block 810). For example, the UE (e.g., using communication manager 906, depicted in FIG. 9) may detect a collision between one or more of a first-stage DCI or a second-stage DCI, of a two-stage DCI, and a symbol in which a PDCCH is not monitored by the UE, as described above.

As further shown in FIG. 8, in some aspects, process 800 may include performing a collision handling for the two-stage DCI based at least in part on the collision, wherein the collision handling is based at least in part on one of: a prioritization of the two-stage DCI, a fallback to a single-stage DCI, or a shift of the first-stage DCI (block 820). For example, the UE (e.g., using communication manager 906, depicted in FIG. 9) may perform a collision handling for the two-stage DCI based at least in part on the collision, wherein the collision handling is based at least in part on one of: a prioritization of the two-stage DCI, a fallback to a single-stage DCI, or a shift of the first-stage DCI, as described above.

Process 800 may include additional aspects, such as any single aspect or any combination of aspects described below and/or in connection with one or more other processes described elsewhere herein.

In a first aspect, the first-stage DCI collides with the symbol, and process 800 includes receiving the first-stage DCI via a PMO, based at least in part on the prioritization of the two-stage DCI.

In a second aspect, alone or in combination with the first aspect, the second-stage DCI collides with the symbol, and process 800 includes receiving the second-stage DCI via a PMO, based at least in part on the prioritization of the two-stage DCI.

In a third aspect, alone or in combination with one or more of the first and second aspects, the first-stage DCI and the second-stage DCI collide with symbols in which PDCCHs are not monitored by the UE, and process 800 includes receiving, based at least in part on the collision handling, the first-stage DCI and the second-stage DCI via PMOs, based at least in part on the prioritization of the two-stage DCI.

In a fourth aspect, alone or in combination with one or more of the first through third aspects, the first-stage DCI or the second-stage DCI does not collide with the symbol.

In a fifth aspect, alone or in combination with one or more of the first through fourth aspects, the second-stage DCI is associated with a dynamically scheduled channel, and a higher layer configured channel associated with the symbol is dropped over the dynamically scheduled channel.

In a sixth aspect, alone or in combination with one or more of the first through fifth aspects, the second-stage DCI is associated with the dynamically scheduled channel based at least in part on a collision with a flexible symbol indicated by an SFI.

In a seventh aspect, alone or in combination with one or more of the first through sixth aspects, the collision is based at least in part on a PDCCH collision with a measurement gap.

In an eighth aspect, alone or in combination with one or more of the first through seventh aspects, the collision is based at least in part on a PDCCH collision with a CLI measurement occasion.

In a ninth aspect, alone or in combination with one or more of the first through eighth aspects, the collision is associated with a PDCCH skipping, and the first-stage DCI and the second-stage DCI fall in a PDCCH skipping duration.

In a tenth aspect, alone or in combination with one or more of the first through ninth aspects, process 800 includes receiving, via a PMO and based at least in part on the collision handling, the single-stage DCI instead of the two-stage DCI, based at least in part on the fallback to the single-stage DCI.

In an eleventh aspect, alone or in combination with one or more of the first through tenth aspects, the PMO does not collide with a symbol in which the PDCCH monitoring is skipped.

In a twelfth aspect, alone or in combination with one or more of the first through eleventh aspects, the first-stage DCI collides with the symbol in which the PDCCH monitoring is not allowed, and process 800 includes receiving, based at least in part on the collision handling, the first-stage DCI, based at least in part on the shift of the first-stage DCI to a slot in which the PDCCH monitoring is allowed.

In a thirteenth aspect, alone or in combination with one or more of the first through twelfth aspects, the slot is a first slot among a plurality of slots in which a PDCCH is transmitted.

In a fourteenth aspect, alone or in combination with one or more of the first through thirteenth aspects, the slot is a first slot associated with a PMO for a second-stage DCI of the two-stage DCI.

In a fifteenth aspect, alone or in combination with one or more of the first through fourteenth aspects, process 800 includes receiving the second-stage DCI based at least in part on a shift of the second-stage DCI to a next PMO for the second-stage DCI.

In a sixteenth aspect, alone or in combination with one or more of the first through fifteenth aspects, process 800 includes receiving the second-stage DCI without a shift of the second-stage DCI.

In a seventeenth aspect, alone or in combination with one or more of the first through sixteenth aspects, the slot is a first slot configured by a network node based at least in part on an offset.

In an eighteenth aspect, alone or in combination with one or more of the first through seventeenth aspects, the slot is configured with a PMO for a specific DCI format, the slot is configured with a specific CORESET, or the slot is configured with a specific search space set.

In a nineteenth aspect, alone or in combination with one or more of the first through eighteenth aspects, the first-stage DCI is not monitored based at least in part on the first-stage DCI colliding with the symbol, and process 800 includes determining to not monitor the second-stage DCI.

In a twentieth aspect, alone or in combination with one or more of the first through nineteenth aspects, the second-stage DCI is not received, based at least in part on the second-stage DCI colliding with the symbol, and process 800 includes determining, based at least in part on the collision handling, to not monitor the first-stage DCI, based at least in part on the first-stage DCI being associated with a single second-stage DCI.

In a twenty-first aspect, alone or in combination with one or more of the first through twentieth aspects, the second-stage DCI is not received, based at least in part on the second-stage DCI colliding with the symbol, and process 800 includes determining, based at least in part on the collision handling, to not monitor the first-stage DCI, based at least in part on a plurality of second-stage DCIs for the first-stage DCI not being received.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 5-7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may detect a collision between one or more of a first-stage DCI or a second-stage DCI, of a two-stage DCI, and a symbol in which a PDCCH is not monitored by the UE. The communication manager 906 may perform a collision handling for the two-stage DCI based at least in part on the collision, wherein the collision handling is based at least in part on one of: a prioritization of the two-stage DCI, a fallback to a single-stage DCI, or a shift of the first-stage DCI.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: detecting a collision between one or more of a first-stage downlink control information (DCI) or a second-stage DCI, of a two-stage DCI, and a symbol in which a physical downlink control channel (PDCCH) is not monitored by the UE; and performing a collision handling for the two-stage DCI based at least in part on the collision, wherein the collision handling is based at least in part on one of: a prioritization of the two-stage DCI, a fallback to a single-stage DCI, or a shift of the first-stage DCI.

Aspect 2: The method of Aspect 1, wherein the first-stage DCI collides with the symbol, and further comprising receiving the first-stage DCI via a PDCCH monitoring occasion, based at least in part on the prioritization of the two-stage DCI.

Aspect 3: The method of any of Aspects 1-2, wherein the second-stage DCI collides with the symbol, and further comprising receiving the second-stage DCI via a PDCCH monitoring occasion, based at least in part on the prioritization of the two-stage DCI.

Aspect 4: The method of any of Aspects 1-3, wherein the first-stage DCI and the second-stage DCI collide with symbols in which PDCCHs are not monitored by the UE, and further comprising receiving, based at least in part on the collision handling, the first-stage DCI and the second-stage DCI via PDCCH monitoring occasions, based at least in part on the prioritization of the two-stage DCI.

Aspect 5: The method of any of Aspects 1-4, wherein the first-stage DCI or the second-stage DCI does not collide with the symbol.

Aspect 6: The method of any of Aspects 1-5, wherein the second-stage DCI is associated with a dynamically scheduled channel, and a higher layer configured channel associated with the symbol is dropped over the dynamically scheduled channel.

Aspect 7: The method of Aspect 6, wherein the second-stage DCI is associated with the dynamically scheduled channel based at least in part on a collision with a flexible symbol indicated by a slot format indicator (SFI).

Aspect 8: The method of any of Aspects 1-7, wherein the collision is based at least in part on a PDCCH collision with a measurement gap.

Aspect 9: The method of any of Aspects 1-8, wherein the collision is based at least in part on a PDCCH collision with a cross-link interference (CLI) measurement occasion.

Aspect 10: The method of any of Aspects 1-9, wherein the collision is associated with a PDCCH skipping, and the first-stage DCI and the second-stage DCI fall in a PDCCH skipping duration.

Aspect 11: The method of any of Aspects 1-10, further comprising: receiving, via a PDCCH monitoring occasion and based at least in part on the collision handling, the single-stage DCI instead of the two-stage DCI, based at least in part on the fallback to the single-stage DCI.

Aspect 12: The method of Aspect 11, wherein the PDCCH monitoring occasion does not collide with a symbol in which the PDCCH monitoring is skipped.

Aspect 13: The method of any of Aspects 1-12, wherein the first-stage DCI collides with the symbol in which the PDCCH monitoring is not allowed, and further comprising receiving, based at least in part on the collision handling, the first-stage DCI, based at least in part on the shift of the first-stage DCI to a slot in which the PDCCH monitoring is allowed.

Aspect 14: The method of Aspect 13, wherein the slot is a first slot among a plurality of slots in which a PDCCH is transmitted.

Aspect 15: The method of Aspect 13, wherein the slot is a first slot associated with a PDCCH monitoring occasion for a second-stage DCI of the two-stage DCI.

Aspect 16: The method of Aspect 13, further comprising: receiving the second-stage DCI based at least in part on a shift of the second-stage DCI to a next PDCCH monitoring occasion for the second-stage DCI.

Aspect 17: The method of Aspect 13, further comprising: receiving the second-stage DCI without a shift of the second-stage DCI.

Aspect 18: The method of Aspect 13, wherein the slot is a first slot configured by a network node based at least in part on an offset.

Aspect 19: The method of Aspect 18, wherein the slot is configured with a PDCCH monitoring occasion for a specific DCI format, the slot is configured with a specific control resource set (CORESET), or the slot is configured with a specific search space set.

Aspect 20: The method of any of Aspects 1-19, wherein the first-stage DCI is not monitored based at least in part on the first-stage DCI colliding with the symbol; and further comprising determining to not monitor the second-stage DCI.

Aspect 21: The method of any of Aspects 1-20, wherein the second-stage DCI is not received, based at least in part on the second-stage DCI colliding with the symbol; and further comprising determining, based at least in part on the collision handling, to not monitor the first-stage DCI, based at least in part on the first-stage DCI being associated with a single second-stage DCI.

Aspect 22: The method of any of Aspects 1-21, wherein the second-stage DCI is not received, based at least in part on the second-stage DCI colliding with the symbol; and further comprising determining, based at least in part on the collision handling, to not monitor the first-stage DCI, based at least in part on a plurality of second-stage DCIs for the first-stage DCI not being received.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors coupled to the one or more memories, the one or more processors individually or collectively configured to:
detect a collision between one or more of a first-stage downlink control information (DCI) or a second-stage DCI, of a two-stage DCI, and a symbol in which a physical downlink control channel (PDCCH) is not monitored by the UE; and
perform a collision handling for the two-stage DCI based at least in part on the collision, wherein the collision handling is based at least in part on one of: a prioritization of the two-stage DCI, a fallback to a single-stage DCI, or a shift of the first-stage DCI.

2. The apparatus of claim 1, wherein the first-stage DCI collides with the symbol, and the one or more processors are further individually or collectively configured to receive the first-stage DCI via a PDCCH monitoring occasion based at least in part on the prioritization of the two-stage DCI.

3. The apparatus of claim 1, wherein the second-stage DCI collides with the symbol, and the one or more processors are further individually or collectively configured to receive the second-stage DCI via a PDCCH monitoring occasion based at least in part on the prioritization of the two-stage DCI.

4. The apparatus of claim 1, wherein the first-stage DCI and the second-stage DCI collide with symbols in which PDCCHs are not monitored by the UE, and the one or more processors are further individually or collectively configured to receive, based at least in part on the collision handling, the first-stage DCI and the second-stage DCI via PDCCH monitoring occasions based at least in part on the prioritization of the two-stage DCI.

5. The apparatus of claim 1, wherein the first-stage DCI or the second-stage DCI does not collide with the symbol.

6. The apparatus of claim 1, wherein the second-stage DCI is associated with a dynamically scheduled channel, and a higher layer configured channel associated with the symbol is dropped over the dynamically scheduled channel.

7. The apparatus of claim 6, wherein the second-stage DCI is associated with the dynamically scheduled channel based at least in part on a collision with a flexible symbol indicated by a slot format indicator (SFI).

8. The apparatus of claim 1, wherein the collision is based at least in part on a PDCCH collision with a measurement gap.

9. The apparatus of claim 1, wherein the collision is based at least in part on a PDCCH collision with a cross-link interference (CLI) measurement occasion.

10. The apparatus of claim 1, wherein the collision is associated with a PDCCH skipping, and the first-stage DCI and the second-stage DCI fall in a PDCCH skipping duration.

11. The apparatus of claim 1, wherein the one or more processors are further individually or collectively configured to:
receive, via a PDCCH monitoring occasion and based at least in part on the collision handling, the single-stage DCI instead of the two-stage DCI based at least in part on the fallback to the single-stage DCI.

12. The apparatus of claim 11, wherein the PDCCH monitoring occasion does not collide with a symbol in which the PDCCH monitoring is skipped.

13. The apparatus of claim 1, wherein the first-stage DCI collides with the symbol, in which the PDCCH monitoring is not allowed, and the one or more processors are further individually or collectively configured to receive, based at least in part on the collision handling, the first-stage DCI based at least in part on the shift of the first-stage DCI to a slot in which the PDCCH monitoring is allowed.

14. The apparatus of claim 13, wherein the slot is a first slot among a plurality of slots in which a PDCCH is transmitted.

15. The apparatus of claim 13, wherein the slot is a first slot associated with a PDCCH monitoring occasion for a second-stage DCI of the two-stage DCI.

16. The apparatus of claim 13, wherein the one or more processors are further individually or collectively configured to:
receive the second-stage DCI based at least in part on a shift of the second-stage DCI to a next PDCCH monitoring occasion for the second-stage DCI.

17. The apparatus of claim 13, wherein the one or more processors are further individually or collectively configured to:
receive the second-stage DCI without a shift of the second-stage DCI.

18. The apparatus of claim 13, wherein the slot is a first slot configured by a network node based at least in part on an offset.

19. The apparatus of claim 18, wherein the slot is configured with a PDCCH monitoring occasion for a specific DCI format, the slot is configured with a specific control resource set (CORESET), or the slot is configured with a specific search space set.

20. The apparatus of claim 1, wherein the first-stage DCI is not monitored, based at least in part on the first-stage DCI colliding with the symbol; and the one or more processors are further individually or collectively configured to: determine, based at least in part on the collision handling, to not monitor the second-stage DCI.

21. The apparatus of claim 1, wherein the second-stage DCI is not received, based at least in part on the second-stage DCI colliding with the symbol; and the one or more processors are further individually or collectively configured to: determine, based at least in part on the collision handling, to not monitor the first-stage DCI, based at least in part on the first-stage DCI being associated with a single second-stage DCI.

22. The apparatus of claim 1, wherein the second-stage DCI is not received, based at least in part on the second-stage DCI colliding with the symbol; and the one or more processors are further individually or collectively configured to: determine, based at least in part on the collision handling, to not monitor the first-stage DCI based at least in part on a plurality of second-stage DCIs for the first-stage DCI not being received.

23. A method of wireless communication performed by a user equipment (UE), comprising:
detecting a collision between one or more of a first-stage downlink control information (DCI) or a second-stage DCI, of a two-stage DCI, and a symbol in which a physical downlink control channel (PDCCH) is not monitored by the UE; and
performing a collision handling for the two-stage DCI based at least in part on the collision, wherein the collision handling is based at least in part on one of: a prioritization of the two-stage DCI, a fallback to a single-stage DCI, or a shift of the first-stage DCI.

24. The method of claim 23, wherein the first-stage DCI collides with the symbol, and further comprising receiving the first-stage DCI via a PDCCH monitoring occasion, based at least in part on the prioritization of the two-stage DCI.

25. The method of claim 23, wherein the second-stage DCI collides with the symbol, and further comprising receiving the second-stage DCI via a PDCCH monitoring occasion, based at least in part on the prioritization of the two-stage DCI.

26. The method of claim 23, wherein the first-stage DCI and the second-stage DCI collide with symbols in which PDCCHs are not monitored by the UE, and further comprising receiving, based at least in part on the collision handling, the first-stage DCI and the second-stage DCI via PDCCH monitoring occasions, based at least in part on the prioritization of the two-stage DCI.

27. The method of claim 23, further comprising:
receiving, via a PDCCH monitoring occasion and based at least in part on the collision handling, the single-stage DCI instead of the two-stage DCI, based at least in part on the fallback to the single-stage DCI.

28. The method of claim 23, wherein the first-stage DCI collides with the symbol in which the PDCCH monitoring is not allowed, and further comprising receiving, based at least in part on the collision handling, the first-stage DCI, based at least in part on the shift of the first-stage DCI to a slot in which the PDCCH monitoring is allowed.

29. A non-transitory computer-readable medium storing a set of instructions for wireless communication, the set of instructions comprising:
one or more instructions that, when executed by one or more processors of a user equipment (UE), cause the UE to:
detect a collision between one or more of a first-stage downlink control information (DCI) or a second-stage DCI, of a two-stage DCI, and a symbol in which a physical downlink control channel (PDCCH) is not monitored by the UE; and
perform a collision handling for the two-stage DCI based at least in part on the collision, wherein the collision handling is based at least in part on one of: a prioritization of the two-stage DCI, a fallback to a single-stage DCI, or a shift of the first-stage DCI.

30. An apparatus for wireless communication, comprising:
means for detecting a collision between one or more of a first-stage downlink control information (DCI) or a second-stage DCI, of a two-stage DCI, and a symbol in which a physical downlink control channel (PDCCH) is not monitored by the apparatus; and
means for performing a collision handling for the two-stage DCI based at least in part on the collision, wherein the collision handling is based at least in part on one of: a prioritization of the two-stage DCI, a fallback to a single-stage DCI, or a shift of the first-stage DCI.
